(19) United States
(12) Patent Application Publication
(10) Pub. No.: US 2026/0312749 A1
(43) Pub. Date: Oct. 8, 2026

(54) MODULATION AND CODING SCHEME FOR MULTIPLE TRANSPORT BLOCK TRANSMISSION

(71) Applicant: Lenovo (United States) Inc., Morrisville, NC (US)

(72) Inventors: Joachim Löhr, Wiesbaden (DE); Alexander Golitschek Edler von Elbwart, Darmstadt (DE)

(73) Assignee: Lenovo (United States) Inc., Morrisville, NC (US)

(21) Appl. No.: 19/170,707

(22) Filed: Apr. 4, 2025

(51) Int. Cl. H04L 5/00; H04L 1/00; H04W 72/1268; H04W 72/232

(52) U.S. Cl. CPC H04L 5/0044; H04L 1/0003; H04L 1/0009; H04W 72/1268; H04W 72/232

(57) ABSTRACT

Various aspects of the present disclosure relate to modulation and coding scheme (MCS) for multiple transport block (TB) transmission. A user equipment (UE) may receive downlink control information (DCI) that includes multiple uplink resource assignments for one or more scheduled uplink transmissions in a transmission opportunity. The UE may generate multiple transport blocks (TBs) based on receiving the DCI and one or more logical channel prioritization (LCP) procedures.

### TECHNICAL FIELD

The present disclosure relates to wireless communications, and more specifically to modulation and coding scheme (MCS) for data transmission.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive downlink control information (DCI) that includes multiple uplink resource assignments for one or more scheduled uplink transmissions in a transmission opportunity; and generate multiple transport blocks (TBs) based on receiving the DCI and one or more logical channel prioritization (LCP) procedures.

A processor (e.g., a standalone processor chipset, or a component of a UE) for wireless communication is described. The processor may be configured to, capable of, or operable to perform one or more operations as described herein. For example, the processor may be configured to, capable of, or operable to receive DCI that includes multiple uplink resource assignments for one or more scheduled uplink transmissions in a transmission opportunity; and generate multiple TBs based on receiving the DCI and one or more LCP procedures.

A method performed or performable by a UE for wireless communication is described. The method may include receiving DCI that includes multiple uplink resource assignments for one or more scheduled uplink transmissions in a transmission opportunity; and generating multiple TBs based on receiving the DCI and one or more LCP procedures.

In some implementations of the UE, the processor, and the method described herein, the DCI is a single DCI that includes the multiple uplink resource assignments. In some implementations of the UE, the processor, and the method described herein, the DCI is a set of DCI, and each DCI of the set of DCI indicates an allocation of an uplink resource assignment of the multiple uplink resource assignments. In some implementations of the UE, the processor, and the method described herein, allocated uplink resources are at least partially overlapping in a time domain. In some implementations of the UE, the processor, and the method described herein, the DCI indicates whether an uplink resource assignment of the multiple uplink resource assignments preempts an earlier assigned uplink resource.

In some implementations of the UE, the processor, and the method described herein, the UE, the processor, and the method may be configured to, capable of, or operable to perform the LCP procedures in an order of a MCS associated with an uplink resource assignment. In some implementations of the UE, the processor, and the method described herein, a first LCP of the LCP procedures is performed for the uplink resource assignment associated with a lowest MCS of multiple MCSs associated with the multiple uplink resource assignments. In some implementations of the UE, the processor, and the method described herein, the UE, the processor, and the method may be configured to, capable of, or operable to transmit uplink control information (UCI) that indicates a configuration of the multiple TBs.

An NE (e.g., a base station) for wireless communication is described. The NE may be configured to, capable of, or operable to perform one or more operations as described herein. For example, the NE may be configured to, capable of, or operable to transmit DCI that includes multiple uplink resource assignments for one or more scheduled uplink transmissions in a transmission opportunity; and receive UCI that indicates a configuration of multiple TBs.

A processor (e.g., a standalone processor chipset, or a component of a NE) for wireless communication is described. The processor may be configured to, capable of, or operable to perform one or more operations as described herein. For example, the processor may be configured to, capable of, or operable to transmit DCI that includes multiple uplink resource assignments for one or more scheduled uplink transmissions in a transmission opportunity; and receive UCI that indicates a configuration of multiple TBs.

A method performed or performable by an NE (e.g., a base station) for wireless communication is described. The method may include transmitting DCI that includes multiple uplink resource assignments for one or more scheduled uplink transmissions in a transmission opportunity; and receiving UCI that indicates a configuration of multiple TBs.

In some implementations of the NE, the processor, and the method described herein, the DCI is at least one of a single DCI that includes the multiple uplink resource assignments; or a set of DCI, and each DCI of the set of DCI indicates an allocation of an uplink resource assignment of the multiple uplink resource assignments.

### BRIEF DESCRIPTION OF THE DRAWINGS

FIG. 1 illustrates an example of a wireless communications system in accordance with aspects of the present disclosure.

FIG. 2 illustrates an example of wireless communication in accordance with aspects of the present disclosure.

FIG. 3 illustrates an example of channel fluctuation, in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of an NE in accordance with aspects of the present disclosure.

FIG. 7 illustrates a flowchart of a method performed by a UE in accordance with aspects of the present disclosure.

FIG. 8 illustrates a flowchart of a method performed by an NE in accordance with aspects of the present disclosure.

### DETAILED DESCRIPTION

In a wireless communications system, a TB refers to a block of data (e.g., a data payload) communicated (e.g., transmitted, sent, output, received, signaled) between a physical layer and one or more higher layers (e.g., medium access control (MAC) layer). At a transmitter side, the MAC layer organizes data to be communicated into TBs, and the physical layer processes (e.g., encodes, modulates) the TBs for communication. At a receiver side, the physical layer processes (e.g., decodes, demodulates) the communication (e.g., reception, received) signal to extract the TBs, and provides the TBs to the MAC layer. The TB can be divided into multiple smaller blocks referred to as data blocks, CBs, or CBGs, allowing larger amounts of data to be encoded, transmitted, and decoded efficiently. Different data blocks, CBs, and/or CBGs can be grouped into or associated with different logical channels (LCHs), where each LCH can carry different types of data (e.g., control data, user data, signaling data, and so forth). Each LCH can be associated with a different priority, such as higher priority LCHs having higher quality of service (QoS) requirements or settings than lower priority LCHs.

A data block is communicated (e.g., transmitted, sent, signaled) on one or more resource blocks (RBs). An RB refers to a unit of time and frequency resources. For example, for 5G NR, an RB may include twelve (12) subcarriers in the frequency domain and a number of orthogonal frequency division multiplexing (OFDM) symbols in the time domain (e.g., depending on the subcarrier spacing).

Some wireless communications systems, such as 6G systems, may support a bandwidth in a wider range than previous wireless communications systems, such as a bandwidth in the range of approximately 100 megahertz (MHz) or more. In such situations, the radio channel (e.g., depending on the environment and/or deployment) may encounter not only small-scale fluctuations within a few decibels (dB), but may also encounter larger fluctuations. This may be compensated for in link adaptation by selecting an MCS that is adapted to the average link quality over the assigned bandwidth. The resource signaling for 5G NR supports only a single MCS signaling per TB for a downlink resource assignment or an uplink resource grant.

Given the single MCS signaling per TB, current (5G NR) link adaptation cannot exploit frequency ranges with better signal-to-interference-plus-noise ratio (SINR) by a reduced forward error correction (FEC) overhead, nor can it assign a more robust FEC to data mapped on frequency ranges with a poor MCS. This becomes particularly relevant for a case of very narrow beams, where there is no or extremely limited flexibility to assign frequency ranges according to the best channel out of a group of UEs (such as RB range 1 to UE1 with good SINR, RB range 2 to UE2 with good SINR). Currently, only a single TB transmission using one MCS is supported in the UE. Accordingly, the current techniques do not support multiple concurrent TBs or physical uplink shared channels (PUSCHs) in a slot (5G NR). Another drawback of the current link adaptation and resource signaling scheme (up to 5G NR) is that the transport block generation and transmission procedure is inefficient, with only a single common MCS applied to all of the data multiplexed in a TB, even though the data of different LCHs may have different QoS requirements. Typically, the MCS for a TB is selected by the network for the highest demanding QoS of the data in a TB and an average link quality over the assigned bandwidth.

Aspects of the present disclosure are described in the context of a wireless communications system. As described herein, the techniques support the concurrent transmission of multiple TBs or PUSCH transmission in uplink communication. Several signaling aspects for allocation of multiple concurrent PUSCH or physical downlink shared channel (PDSCH) transmissions for one transmission opportunity are described. Additionally, techniques are described that provide for the network to pre-empt uplink (UL) and downlink (DL) allocations, or schedule additional resources for a transmission opportunity.

Aspects of this disclosure are related to a DCI that indicates ranges of RBs which are assigned to a hybrid automatic repeat request (HARQ) process or TB. A DCI indicates or allocates multiple resources (PUSCH or PDSCH) for one serving cell, and each of them being associated with one or more TBs which are (at least partially) overlapping in time. In an example, a single DCI schedules multiple HARQ processes and multiple PDSCHs or PUSCHs in a given transmission opportunity on a single carrier or serving cell.

Aspects of this disclosure are related to a DCI that allocates UL resources for a transmission opportunity (e.g., slot, symbol, or transmission time interval (TTI)) and indicates whether the UL grant overrides or pre-empts UL resources which have been allocated to a UE for the slot, symbol, or TTI. The DCI contains an indication as to whether the allocated UL resources are additionally allocated to an already existing UL allocation, or whether an UL grant pre-empts another UL grant for the same transmission opportunity.

Aspects of this disclosure are related to a UE that determines, in response to the reception of an UL grant or DCI allocating UL resources, whether to generate multiple TBs and transmit them concurrently on the allocated UL resources, or whether to generate a single TB and transmit it on the allocated UL resources. The UE may determine, based on the data available for transmission in the buffer and/or the associated QoS requirements, whether to segregate the data into multiple TBs, which may be transmitted with different MCS. Different MCS, or different MCS levels, refers to different coding rates and/or modulation schemes.

Aspects of the present disclosure are described in the context of a wireless communications system. In the wireless communications system, a UE and an NE (e.g., a base station, gNB, network entity, network node) may support wireless communication, including reception and/or transmission of wireless communication using time-frequency resources. For example, the UE and the NE may support communicating signals (e.g., carrying control information, data, or the like). It should be understood that various terms may be used interchangeably with “communicating,” such as “signaling,” “transmitting,” “receiving,” “outputting,” “forwarding,” “relaying,” “retrieving,” “obtaining,” and so forth.

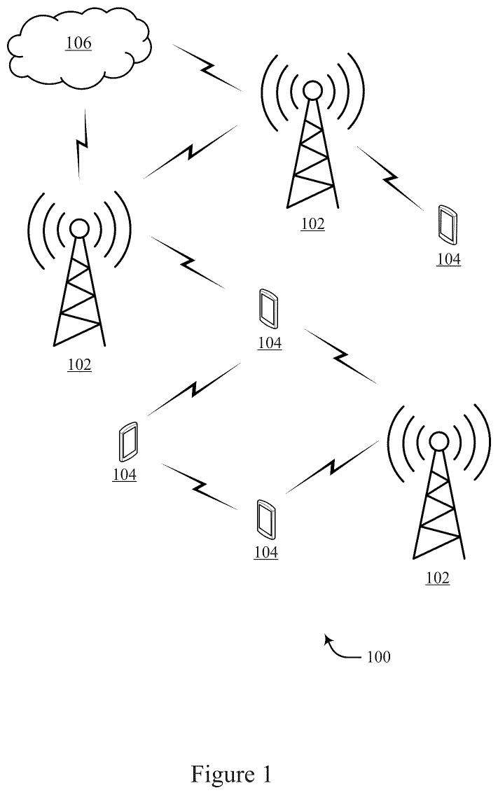

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0,μ=1, μ=2,μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Some wireless communications systems may support the concurrent transmission of multiple TBs or PUSCH transmission in uplink communication. Several signaling aspects for allocation of multiple concurrent PUSCH or PDSCH transmissions for one transmission opportunity are described. Additionally, techniques are described that provide for the network to pre-empt UL and DL allocations, or schedule additional resources for a transmission opportunity. For example, an NE 102 and a UE 104 in the wireless communications system 100 may support aspects of the described techniques for MCS for multiple TB transmission.

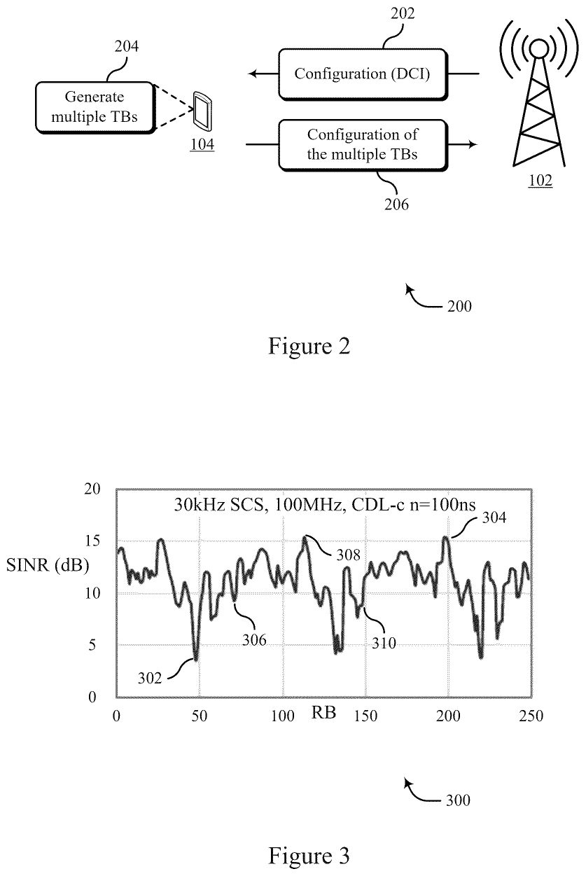

FIG. 2 illustrates an example 200 of wireless communication in accordance with aspects of the present disclosure. In the example 200, an NE 102 communicates (e.g., transmits, sends, signals) a configuration 202 (e.g., a configuration message) to a UE 104. The configuration 202 (e.g., DCI) includes multiple uplink resource assignments for one or more scheduled uplink transmissions in a transmission opportunity for the UE 104. The UE 104 receives the DCI that includes the multiple uplink resource assignments for the one or more scheduled uplink transmissions in the transmission opportunity. The UE 104 generates multiple TBs based on LCP procedures (at 204). The UE 104 communicates (e.g., transmits, sends, signals), to the NE 102, UCI 206 that indicates a configuration of the multiple TBs. The NE 102 receives the UCI that indicates the configuration of the multiple TBs.

FIG. 3 illustrates an example 300 of channel fluctuation in accordance with aspects of the present disclosure. The example 300 illustrates SINR in a transmit (Tx) wireless communication channel having 30 kilohertz (kHz) subcarrier spacing (SCS) across a 100 MHz bandwidth, using a clustered delay line (CDL) profile CDL-C, where n=100 nanoseconds. As illustrated, the Tx channel has channel fluctuation of greater than 10 dB, such as from approximately 4 dB at 302 to over 15 dB at 304. Using the techniques discussed herein, the UE 104 can select MCS for multiple TB transmission, such as an MCS for RB 75 through RB 120 because the channel fluctuation between RB 75 and RB 120 is approximately 6 dB (e.g., 9 dB at 306 and 15 dB at 308) and a different MCS for RB 120 through RB 150 because the channel fluctuation between RB 120 and RB 150 is approximately 11 dB (e.g., 15 dB at 308 and 4 db at 310).

With reference to frequency resource assignment (DL/UL), according to 3rd Generation Partnership Project (3GPP) technical specification (TS) 38.212, both UL and DL resource assignments support only 1 single MCS assignment applicable to all assigned resource blocks. DCI Format 0_0 refers to a modulation and coding scheme of 5 bits. DCI Format 0_1 refers to, for TB 1, a modulation and coding scheme of 5 bits as defined in Clause 6.1.4.1 of 3GPP TS 38.214, and for TB 2 (only present if maxRank or maxMIMO-Layers is larger than 4), a modulation and coding scheme of 5 bits as defined in Clause 6.1.4.1 of 3GPP TS 38.214.

DCI Format 0_2 refers to a modulation and coding scheme of 5 bits as defined in Clause 6.1.4.1 of 3GPP TS 38.214. DCI Format 0_3 is used for the scheduling of one PUSCH in one cell, or multiple PUSCHs in multiple cells with one PUSCH per cell. The modulation and coding scheme is a number of bits determined by the following: block number 1, block number 2, . . . , block number N_{cell}^{UL}. Each block corresponds to the modulation and coding scheme for a cell, and the blocks are placed according to an ascending order of a serving cell index, with block number 1 corresponding to the modulation and coding scheme for the cell with the smallest serving cell index. Each block is 5 bits as defined in Clause 6.1.4.1 of 3GPP TS 38.214.

DCI Format 1_0 refers to a modulation and coding scheme of 5 bits. DCI Format 1_1, for TB 1, refers to a modulation and coding scheme of 5 bits as defined in Clause 5.1.3.1 of 3GPP TS 38.214, and for TB 2 (only present if maxNrofCodeWordsScheduledByDCI equals 2), refers to a modulation and coding scheme of 5 bits as defined in Clause 5.1.3.1 of 3GPP TS 38.214. DCI Format 1_2 refers to a modulation and coding scheme of 5 bits as defined in Clause 5.1.3.1 of 3GPP TS 38.214.

DCI Format 1_3 is used for the scheduling of one PDSCH in one cell, or multiple PDSCHs in multiple cells with one PDSCH per cell. For TB 1: the modulation and coding scheme is a number of bits determined by the following: block number 1, block number 2, . . . , block number N_{cell}^{DL}. Each block corresponds to the modulation and coding scheme for a cell, and the blocks are placed according to an ascending order of a serving cell index, with block number 1 corresponding to the modulation and coding scheme for the cell with the smallest serving cell index. Each block is 5 bits as defined in Clause 6.1.4.1 of 3GPP TS 38.214. For TB 2: the modulation and coding scheme is a number of bits determined by the following: block number 1, block number 2, . . . , block number N_{cell}^{DL,3}.

DCI Format 4_0 refers to a modulation and coding scheme of 5 bits as defined in Clause 5.1.3 of 3GPP TS 38.214 . DCI Format 4_1 refers to a modulation and coding scheme of 5 bits as defined in Clause 5.1.3 of 3GPP TS 38.214 . DCI Format 4_2 refers to, for TB 1, a modulation and coding scheme of 5 bits as defined in Clause 5.1.3.1 of 3GPP TS 38.214, and for TB 2 (only present if maxNrofCodeWordsScheduledByDCI equals 2), a modulation and coding scheme of 5 bits as defined in Clause 5.1.3.1 of 3GPP TS 38.214.

While DCI formats 0_3/1_3 are capable of signaling a plurality of MCS fields, each such MCS field is applicable to a whole cell, and therefore to a single TB (i.e., the same MCS is applied to a TB).

Aspects of the present disclosure include techniques that support the concurrent transmission of multiple TBs or PUSCH transmission in uplink communication. Several signaling aspects for allocation of multiple concurrent PUSCH or PDSCH transmissions for one transmission opportunity are described. Additionally, techniques are described that provide for the network to pre-empt UL and DL allocations, or schedule additional resources for a transmission opportunity.

In some techniques, the LCP and TB generation procedure would be performed regardless of the QoS requirements of a LCH (e.g., only the logical channel priority and the configured physical resource block (PRB) for LCHs determines the number of resources and/or bits allocated to a LCH during LCP. A single TB with a common MCS is used regardless of the different types of data multiplexed in the TB. Therefore, the corresponding PUSCH transmission would be inefficient from a resource usage and spectral efficiency perspective. The techniques described herein provide for an increased spectral efficiency by considering the QoS requirements of data multiplexed in a TB and selection of an appropriate MCS. Multiple concurrent TBs and PUSCHs are supported to benefit from an optimized, efficient link adaptation by exploiting frequency ranges with better SINR by a reduced FEC overhead, or by assigning a more robust FEC to data mapped on frequency ranges with a poor SINR.

In one or more implementations, a DCI indicates ranges of RBs which are assigned to a HARQ process or TB. A DCI indicates or allocates multiple resources (PUSCH or PDSCH) for one serving cell, and each of them being associated with one or more TBs which are (at least partially) overlapping in time. In one example, a single DCI schedules multiple HARQ processes and multiple PDSCHs or PUSCHs in a given transmission opportunity on a single carrier or serving cell (e.g., active bandwidth part of the serving cell).

In one or more implementations, a DCI allocates UL resources for a transmission opportunity (e.g., slot, symbol, or transmission time interval (TTI)) and indicates whether the UL grant overrides or pre-empts UL resources which have been allocated to a UE for the slot, symbol, or TTI. The DCI contains an indication or field that indicates whether the allocated UL resources are additionally allocated to the potentially already existing UL allocation in the slot, symbol, or TTI, or whether the UL grant pre-empts another UL grant for the same transmission opportunity.

In one or more implementations, a UE determines, in response to the reception of an UL grant or DCI allocating UL resources, whether to generate multiple TBs and transmit them concurrently on the allocated UL resources, or whether to generate a single TB and transmit it on the allocated UL resources. The UE may determine, based on the data available for transmission in the buffer and/or the associated QoS requirements, whether to segregate the data into multiple TBs, which may be transmitted with different MCS. Different MCS, or different MCS levels, refers to different coding rates and/or modulation schemes. A table or other data structure of different coding rate and modulation scheme combinations can be known to both a UE and an NE, with an index into the table or other data structure being used to identify which of the different MCS, or different MCS levels, is being used.

With reference to multiple TBs in a slot, symbol, or TTI, a DCI allocates multiple TBs or HARQ processes within a slot. In an implementation, a highest priority data is mapped to the most demanding LCHs, where a first LCP is applied for the lowest MCS, and a second LCP is applied to a second lowest MCS. In an alternative implementation, a UE applies LCP in the order of allocations (i.e., a first signaled allocation and MCS is used for a first LCP, a second signaled allocation and MCS within DCI is used for the second LCP, etc.). In an implementation for power control behavior for a multi-TB transmission, a DCI allocates UL resources (as in legacy) and a UE determines whether to generate multiple TBs within the allocated UL resources. A UCI indicates TB information (similar to UL DCI information), and HARQ aspects are considered, such as which HARQ processes to use for the multiple TBs.

In one or more implementations, a DCI indicates ranges of RBs which are assigned to a HARQ process or TB. According to an implementation, a DCI indicates or allocates multiple resources (PUSCH or PDSCH) for one serving cell, with each of resources associated with one or more TBs which are (at least partially) overlapping in time. In an example, a single DCI schedules multiple HARQ processes and multiple PDSCHs or PUSCHs in a given transmission opportunity on a single carrier or serving cell (e.g., active Bandwidth part of a serving cell). In an example, the multiple resources are consecutive in frequency domain (e.g., a consecutive set of RBs). In an implementation, the DCI indicates a starting RB index and multiple length indications, one for each RB range (similar encoding as frequency domain resource allocation (FDRA)). In an alternative implementation, the DCI indicates multiple start and length indications for each RB range (e.g., such as if the resources or RB ranges are not consecutive).

In an implementation, there is only one time domain allocation information for the multiple TBs (e.g., multiple TBs are fully overlapping in time domain). In an example, the DCI indicates multiple TB or HARQ related information, one for each set of RBs and/or resources. In an implementation, the TB or HARQ related information includes one or more of a HARQ process identifier (ID), a new data indicator (NDI) of whether a TB includes new data or retransmitted data, a redundancy version (RV), and an MCS. In an example, only one (starting) HARQ process ID is signaled within the DCI (e.g., HARQ process IDs for the multiple TBs are consecutive). In an implementation, a single DCI schedules multiple PUSCHs or PDSCHs in a given transmission opportunity on multiple bandwidth parts (BWPs). In an example, the DCI includes a BWP ID indicating the BWP on which the corresponding PUSCH or PDSCH is allocated.

In one or more implementations, a UE receives multiple DCIs and/or physical downlink control channels (PDCCHs) for allocating multiple UL or DL resources within a slot (e.g., each DCI or PDCCH allocates UL or DL resources for a single TB (not considering MIMO) as in legacy. In an implementation, a UE may have multiple UL grants or DL allocations for a slot on a serving cell (e.g., UL grants or DL allocations are (at least partially) overlapping in time domain). In an example, a UE generates multiple TBs which are transmitted concurrently in the corresponding serving cell according to the received UL grants. In an implementation, a UE determines whether the content of the multiple DCIs or PDCCHs is consistent. For example, the UE determines whether the transmit power control (TPC) commands signaled within the received DCIs are indicating the same value, assuming that UL power control is performed per cell as currently specified.

If the content of the multiple DCIs is consistent, the UE processes the DCIs and performs the corresponding related actions (e.g., generation of TBs and corresponding PUSCH transmissions, or reception and decoding on corresponding PDSCHs. In an implementation, the UE ignores a DCI or PDCCH if the content of the DCI or PDCCH (e.g., field(s) signaled within the DCI) is not consistent with the content of other DCIs received. In an example, the DCIs and UL grants allocating overlapping UL resources (e.g., multiple UL or PUSCH resources on the active UL BWP of a serving cell) should indicate the same numerology for the UL resources.

In one or more implementations, a DCI includes a field that indicates whether to perform one common “virtual” LCP procedure across multiple UL resource assignments. In an implementation, the field is a one-bit flag (e.g., an indication as to when set to 1, that the UE should apply a common virtual LCP procedure across multiple UL grants scheduling multiple overlapping UL or PUSCH resources). In an example, a UE performs, in response to the reception of a DCI allocating multiple UL resource assignments and the field set to one, a single common LCP procedure across the multiple UL grants or PUSCH allocations allocating UL resources for an initial transmission. In an implementation, the UE accumulates the individual UL resources assigned by the individual UL grants or allocations and performs one common LCP procedure on the sum of the UL resources. In an example, the UE determines the corresponding TB sizes for each of the UL grants and calculates an accumulated TB size (e.g., a sum of the individual TB size(s)). Subsequently, the UE can perform an LCP procedure on the accumulated TB size. The resulting “virtual” common TB is then mapped to the individual UL grants and/or TBs.

In an implementation, a field within a DCI (UL grant) indicates whether a UE shall multiplex data of different LCHs on the UL resources allocated by the UL grant. In an example, the UE only multiplexes data of the highest priority LCHs being available for transmission into the allocated UL resources in response to the reception of a DCI indicating not to multiplex data of different LCHs into the allocated UL resources. For a scenario where a UE has received multiple (overlapping) UL grants, the UE may, for each of the UL grants, only transmit data of one LCH (e.g., a highest priority LCH), in the corresponding TB.

In one or more implementations, a DCI allocates UL resources for a slot, symbol, or TTI and indicates whether the UL grant overrides or pre-empts the UL resources which have been allocated to the (same) UE for the slot, symbol, or TTI. In an implementation, the DCI contains an indication or field which indicates whether the allocated UL resources are additionally allocated to the potentially already existing UL allocation in the slot, symbol, or TTI, or whether the UL grant pre-empts another UL grant for the same slot, symbol, or TTI. For a scenario in which the UE has a configured uplink grant, the network may override or adapt some of the semi-persistent periodic UL resources of the configured grant (CG) by sending a dynamic UL grant or DCI. In order to select between the allocation of additional UL resources (e.g., CG uplink resources for voice over IP (VOIP) and additional UL resources in the same slot or TTI for other eMBB traffic) and pre-empting the CG UL resources (e.g., allocating resources with a different MCS or at a different frequency location), a new field or indication is implemented to be included in a DCI.

In an implementation, a DCI that allocates PUSCH or PDSCH resources contains an index or index field, which is used to indicate whether a DCI either overrides a previous DL or UL allocation or grant for a transmission opportunity, or whether the DCI allocates additional UL or DL resources for the transmission opportunity. In an example, a DCI with the index field, which is set to a same number as a DCI previously received allocating resources for the same transmission opportunity, indicates an override of the previously allocated resources (for UL or DL). If a UE receives a DCI scheduling resources for a transmission opportunity with an index field set to a number for which no DCI has been received, an additional resource allocation (UL or DL grant) for the transmission opportunity is indicated.

In one or more implementations, a UE determines, in response to the reception of an UL grant or DCI allocating UL resources whether to generate multiple TBs and transmit them concurrently on the allocated UL resources, or whether to generate a single TB and transmit it on the allocated UL resources. In an implementation, the UE determines, based on the data available for transmission in the buffer and/or the associated QoS requirements, whether to segregate the data into multiple TBs, which may be transmitted with different MCS. In order to accommodate different QoS requirements, a UE can determine the multi-TB transmission over the option to multiplex data of different QoS into a single TB and transmit it with one common MCS. In an implementation, the UE determines, based on predefined criteria and/or conditions, whether to generate single or multiple TBs for the allocated PUSCH resources, such that the UE might override a network grant. In an example, the criteria may be one or more of a number of RBs is greater than a preconfigured threshold (for large bandwidth (BW)); data of different LCHs which have different QoS requirements are available for transmission; or UCI is allocated by the network, which indicates the control information for decoding of multiple TBs.

In an implementation, a DCI or UL grant indicates whether a UE is allowed to determine whether to send a single or multiple TBs on the allocated PUSCH resources. In an example, a one-bit field is used to indicate that the UE is allowed to determine the single or multi-TB option. If a UE selects the multi-TB transmission option, the UE signals along with the PUSCHs, UCI incudes control information usable to decode the multiple TBs (e.g., information of the corresponding MCS, TB size, RB size used for a PUSCH, or HARQ related information). The selection of the MCS for a TB, if a UE transmits multiple TBs concurrently, is an implementation option according to the QoS requirements of the LCH which is multiplexed in the corresponding UL resources or TB. In an example, a UE selects (partially) the HARQ processes used for the multi-TB transmission. In an implementation, the UE selects the HARQ process indicated in the DCI or UL grant (assuming only one HARQ process is indicated in the DCI) and further selects HARQ processes which are available for new transmissions (e.g., for a HARQ buffer flushed or successful reception of an UL transmission for a HARQ process that was acknowledged by a receiver). In an example, the DCI includes HARQ process IDs of potential HARQ process candidates which the UE may use for a multi-TB transmission. In another implementation, the network configures the maximum number of TBs which the UE is allowed to concurrently transmit. In an alternative option, a DCI indicates the maximum allowed number of TBs for the corresponding PUSCH allocation.

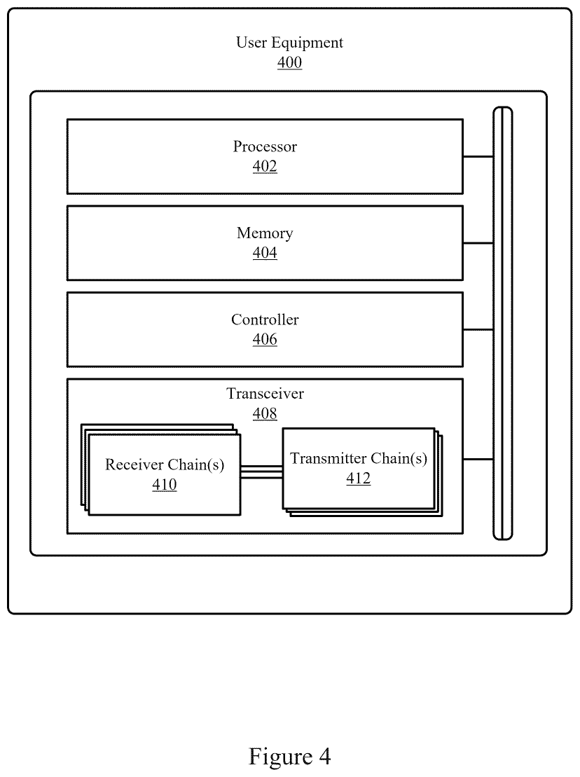

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such as the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to or operable to cause the UE 400 to perform one or more of the functions described herein (e.g., executing, by the processor 402, instructions stored in the memory 404). For example, the processor 402 may support wireless communication at the UE 400 in accordance with examples as disclosed herein. The UE 400 may be configured to or operable to support a means for receiving DCI that includes multiple uplink resource assignments for one or more scheduled uplink transmissions in a transmission opportunity; and generating multiple TBs based at least in part on receiving the DCI and one or more LCP procedures.

Additionally, the UE 400 may be configured to or operable to support any one or combination of the DCI is a single DCI that includes the multiple uplink resource assignments. The DCI is a set of DCI, and each DCI of the set of DCI indicates an allocation of an uplink resource assignment of the multiple uplink resource assignments. Allocated uplink resources are at least partially overlapping in a time domain. The DCI indicates an uplink resource assignment of the multiple uplink resource assignments preempts an earlier assigned uplink resource. The method further including performing the LCP procedures in an order of a MCS associated with an uplink resource assignment. A first LCP of the LCP procedures is performed for the uplink resource assignment associated with a lowest MCS of multiple MCSs associated with the multiple uplink resource assignments. The method further including transmitting UCI that indicates a configuration of the multiple TBs.

Additionally, or alternatively, the UE 400 may support at least one memory (e.g., the memory 404) and at least one processor (e.g., the processor 402) coupled with the at least one memory and configured to or operable to cause the UE to receive DCI that includes multiple uplink resource assignments for one or more scheduled uplink transmissions in a transmission opportunity; and generate multiple TBs based at least in part on receiving the DCI and one or more LCP procedures.

Additionally, the UE 400 may be configured to or operable to support any one or combination of the DCI is a single DCI that includes the multiple uplink resource assignments. The DCI is a set of DCI, and each DCI of the set of DCI indicates an allocation of an uplink resource assignment of the multiple uplink resource assignments. Allocated uplink resources are at least partially overlapping in a time domain. The DCI indicates whether an uplink resource assignment of the multiple uplink resource assignments preempts an earlier assigned uplink resource. The at least one processor is operable to cause the UE to perform the LCP procedures in an order of a MCS associated with an uplink resource assignment. A first LCP of the LCP procedures is performed for the uplink resource assignment associated with a lowest MCS of multiple MCSs associated with the multiple uplink resource assignments. The at least one processor is operable to cause the UE to transmit UCI that indicates a configuration of the multiple TBs.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas to receive a signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

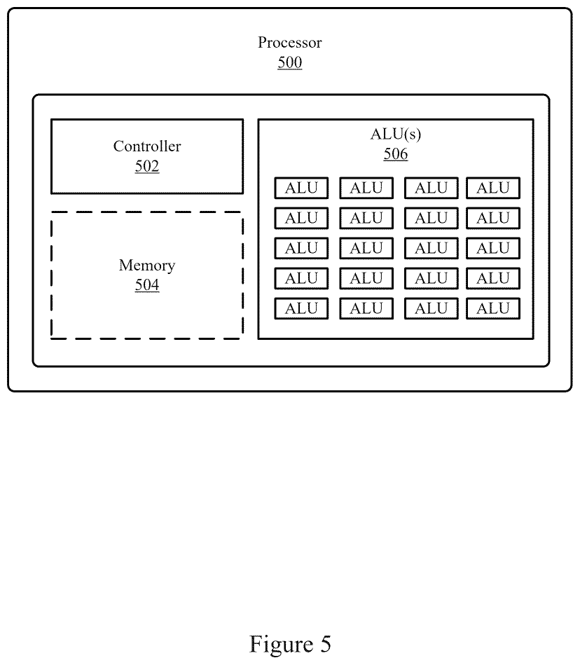

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory addresses of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, ALUs 506, and other functional units of the processor 500.

The memory 504 may include one or more caches (e.g., memory local to or included in the processor 500 or other memory, such as RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, and the controller 502, and may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 may be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. The processor 500 may be configured to support at least one controller (e.g., the controller 502) coupled with at least one memory (e.g., the memory 504) and configured to or operable to cause the processor to receive DCI that includes multiple uplink resource assignments for one or more scheduled uplink transmissions in a transmission opportunity; and generate multiple TBs based on receiving the DCI and one or more LCP procedures.

Additionally, the processor 500 may be configured to or operable to support any one or combination of the DCI is a single DCI that includes the multiple uplink resource assignments. The DCI is a set of DCI, and each DCI of the set of DCI indicates an allocation of an uplink resource assignment of the multiple uplink resource assignments. Allocated uplink resources are at least partially overlapping in a time domain. The DCI indicates whether an uplink resource assignment of the multiple uplink resource assignments preempts an earlier assigned uplink resource. The at least one processor is operable to cause the UE to perform the LCP procedures in an order of a MCS associated with an uplink resource assignment. A first LCP of the LCP procedures is performed for the uplink resource assignment associated with a lowest MCS of multiple MCSs associated with the multiple uplink resource assignments. The at least one processor is operable to cause the UE to transmit UCI that indicates a configuration of the multiple TBs.

The processor 500 may support wireless communication in accordance with examples as disclosed herein. The processor 500 may be configured to support at least one controller (e.g., the controller 502) coupled with at least one memory (e.g., the memory 504) and configured to or operable to cause the processor to transmit DCI that includes multiple uplink resource assignments for one or more scheduled uplink transmissions in a transmission opportunity; and receive UCI that indicates a configuration of multiple TBs.

Additionally, the processor 500 may be configured to or operable to support any one or combination of a single DCI that includes the multiple uplink resource assignments; or a set of DCI, and each DCI of the set of DCI indicates an allocation of an uplink resource assignment of the multiple uplink resource assignments.

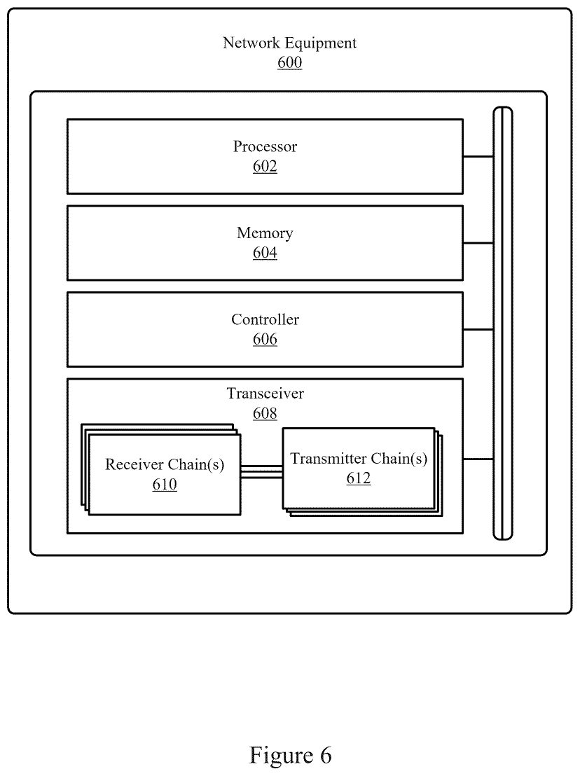

FIG. 6 illustrates an example of an NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein. The NE 600 may be configured to or operable to support a means for transmitting DCI that includes multiple uplink resource assignments for one or more scheduled uplink transmissions in a transmission opportunity; and receiving UCI that indicates a configuration of multiple TBs

Additionally, the NE 600 may be configured to or operable to support any one or combination of the DCI is at least one of a single DCI that includes the multiple uplink resource assignments; or a set of DCI, and each DCI of the set of DCI indicates an allocation of an uplink resource assignment of the multiple uplink resource assignments.

Additionally, or alternatively, the NE 600 may support at least one memory (e.g., the memory 604) and at least one processor (e.g., the processor 602) coupled with the at least one memory and configured to or operable to cause the NE to transmit DCI that includes multiple uplink resource assignments for one or more scheduled uplink transmissions in a transmission opportunity; and receive UCI that indicates a configuration of multiple TBs.

Additionally, the NE 600 may be configured to or operable to support any one or combination of the DCI is at least one of a single DCI that includes the multiple uplink resource assignments; or a set of DCI, and each DCI of the set of DCI indicates an allocation of an uplink resource assignment of the multiple uplink resource assignments.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

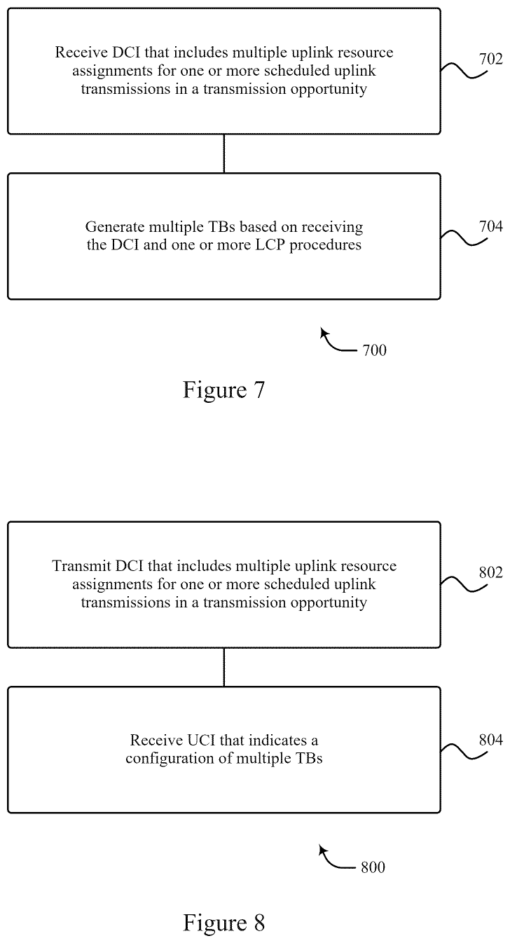

FIG. 7 illustrates a flowchart of a method 700 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 702, the method may include receiving DCI that includes multiple uplink resource assignments for one or more scheduled uplink transmissions in a transmission opportunity. The operations of 702 may be performed in accordance with examples as described herein. In some implementations, aspects of the operations of 702 may be performed by a UE as described with reference to FIG. 4.

At 704, the method may include generating multiple TBs based on receiving the DCI and one or more LCP procedures. The operations of 704 may be performed in accordance with examples as described herein. In some implementations, aspects of the operations of 704 may be performed by a UE as described with reference to FIG. 4.

FIG. 8 illustrates a flowchart of a method 800 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 802, the method may include transmitting DCI that includes multiple uplink resource assignments for one or more scheduled uplink transmissions in a transmission opportunity. The operations of 802 may be performed in accordance with examples as described herein. In some implementations, aspects of the operations of 802 may be performed by an NE as described with reference to FIG. 6.

At 804, the method may include receiving UCI that indicates a configuration of multiple TBs. The operations of 804 may be performed in accordance with examples as described herein. In some implementations, aspects of the operations of 804 may be performed by an NE as described with reference to FIG. 6.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive downlink control information (DCI) that includes multiple uplink resource assignments for one or more scheduled uplink transmissions in a transmission opportunity; and
generate multiple transport blocks (TBs) based at least in part on receiving the DCI and one or more logical channel prioritization (LCP) procedures.

2. The UE of claim 1, wherein the DCI is a single DCI that includes the multiple uplink resource assignments.

3. The UE of claim 1, wherein the DCI is a set of DCI, and each DCI of the set of DCI indicates an allocation of an uplink resource assignment of the multiple uplink resource assignments.

4. The UE of claim 1, wherein allocated uplink resources are at least partially overlapping in a time domain.

5. The UE of claim 1, wherein the DCI indicates whether an uplink resource assignment of the multiple uplink resource assignments preempts an earlier assigned uplink resource.

6. The UE of claim 1, wherein the at least one processor is operable to cause the UE to perform the LCP procedures in an order of a modulation and coding scheme (MCS) associated with an uplink resource assignment.

7. The UE of claim 6, wherein a first LCP of the LCP procedures is performed for the uplink resource assignment associated with a lowest MCS of multiple MCSs associated with the multiple uplink resource assignments.

8. The UE of claim 1, wherein the at least one processor is operable to cause the UE to transmit uplink control information (UCI) that indicates a configuration of the multiple TBs.

9. A method performed by a user equipment (UE), the method comprising:
receiving downlink control information (DCI) that includes multiple uplink resource assignments for one or more scheduled uplink transmissions in a transmission opportunity; and
generating multiple transport blocks (TBs) based at least in part on receiving the DCI and one or more logical channel prioritization (LCP) procedures.

10. The method of claim 9, wherein the DCI is a single DCI that includes the multiple uplink resource assignments.

11. The method of claim 9, wherein the DCI is a set of DCI, and each DCI of the set of DCI indicates an allocation of an uplink resource assignment of the multiple uplink resource assignments.

12. The method of claim 9, wherein allocated uplink resources are at least partially overlapping in a time domain.

13. The method of claim 9, wherein the DCI indicates an uplink resource assignment of the multiple uplink resource assignments preempts an earlier assigned uplink resource.

14. The method of claim 9, further comprising:
performing the LCP procedures in an order of a modulation and coding scheme (MCS) associated with an uplink resource assignment.

15. The method of claim 14, wherein a first LCP of the LCP procedures is performed for the uplink resource assignment associated with a lowest MCS of multiple MCSs associated with the multiple uplink resource assignments.

16. The method of claim 9, further comprising:
transmitting uplink control information (UCI) that indicates a configuration of the multiple TBs.

17. A network equipment (NE) for wireless communication, comprising:
at least one memory; and
at least one processor coupled with the at least one memory and operable to cause the NE to:
transmit downlink control information (DCI) that includes multiple uplink resource assignments for one or more scheduled uplink transmissions in a transmission opportunity; and
receive uplink control information (UCI) that indicates a configuration of multiple transport blocks (TBs).

18. The NE of claim 17, wherein the DCI is at least one of:
a single DCI that includes the multiple uplink resource assignments; or
a set of DCI, and each DCI of the set of DCI indicates an allocation of an uplink resource assignment of the multiple uplink resource assignments.

19. A method performed by a network equipment (NE), the method comprising:
transmitting downlink control information (DCI) that includes multiple uplink resource assignments for one or more scheduled uplink transmissions in a transmission opportunity; and
receiving uplink control information (UCI) that indicates a configuration of multiple transport blocks (TBs).

20. The method of claim 19, wherein the DCI is at least one of:
a single DCI that includes the multiple uplink resource assignments; or
a set of DCI, and each DCI of the set of DCI indicates an allocation of an uplink resource assignment of the multiple uplink resource assignments.
